(19) United States
(12) Patent Application Publication
(10) Pub. No.: US 2007/0215551 A1
(43) Pub. Date: Sep. 20, 2007

(54) Method And Device For Treatment And Loop-Processing Of Waste Waters

(76) Inventor: Ulrich Braun, Freiburg (DE)

Correspondence Address: DLA PIPER US LLP, 4365 EXECUTIVE DRIVE, SUITE 1100, SAN DIEGO, CA, 92121-2133, US

(21) Appl. No.: 10/561,371

(22) PCT Filed: Jun. 15, 2004
(86) PCT No.: PCT/EP04/06439

§ 371 Date: Jan. 18, 2007

(30) Foreign Application Priority Data
Jun. 15, 2003 (DE) 103 27 167.8
Jun. 15, 2003 (DE) 103 27 168.6
Jun. 16, 2003 (DE) 103 27 346.8
Sep. 15, 2003 (DE) 103 42 849.6

(51) Int. Cl. C02F 1/42; C02F 9/14

(52) U.S. Cl. 210/664; 210/195.1

(57) ABSTRACT

The here presented invention refers to a method and device for separating inorganic salts from loop-processed toilet waste water as well as its de-colouring. Additionally, a treatment method without a biological step is presented, whereas here as well the toilet waste water is loop-processed reasoned by water savings and amounts reduction preferably for mobile units. The here presented invention refers to a method and device refer also to the extraction of nutrient salts from toilet and/or urinal waste waters, whereas the method comprises the steps urea cleavage, removal of ammonium, and reuse of the toilet flushing water for toilet flushing and these steps are executed preferably in separated devices.

### FIELD OF THE INVENTION

The invention being presented here relates to a method and device for treatment of domestic waste waters preferably in mobile and/or stationary units.

### DESCRIPTION OF THE INVENTION

1. Definitions

Brown water is here defined as separately collected waste water, possibly not mixed with other waste waters, which is mainly laden with faeces from all kinds of toilets without, or with little load of urine, or from the faecal-laden outlet of urine separation toilets.

Yellow water is defined as separately collected waste water, possibly not mixed with other waste waters, which is mainly laden with urine and stems from all kinds of urinals and/or from the urine-laden outlet of urine separation toilets with, or without water.

Black water is here defined as separately collected, and possibly not mixed with other waste waters, domestic waste water mainly laden with urine and faeces and/or other, similarly composed waste waters from agriculture (e.g. pig manure) and/or other sources. For this application it is imperative, that black water is the generic term for mainly urine and faecal loaded waste water. Black water can be drained and collected in a separate sewerage net. Moreover, the black water can be received in surges in a common sewerage net for grey and black water, and treated separately.

Grey water is here defined as separately collected, and not, or nearly not mixed with urine and/or faecal loaded domestic waste water and/or as other waste water of similar composition stemming from laundries and/or other sources, which can be received in one or several separate sewerage nets. According to its origin and/or composition it can be subdivided into several grey water partial streams. The grey water can be composed of all conceivable combinations of all conceivable numbers of domestic and similar waste water sources, but must not contain the main part of separately drained black water, although a portion of faecal and/or urinal waste water admixed to one or several partial streams of the grey water does not make a difference to this definition.

Oxidation reactor is here defined as a vessel containing a liquid, in which at least one oxidant is feed in, that bonds and/or causes bonding chemically at other elements and chemical compounds in this vessel. It includes all physical, chemical and/or biological oxidation reactors known to the a skilled person, such as Ozonisation, UV-Oxidation, Activated Sludge Reactor, etc.

Toilet flushing water is here defined as water, which is used for the flushing of toilets and/or urinals.

Filtration covers all screen filters and/or membrane (filtration) methods that can be used in waste water purification and potable water recovery. It includes all filtration and/or membrane methods known to the a skilled person, such as e.g. filter presses, rotting tanks, nano, ultra or micro filtration, reverse osmosis, etc., which are for instance described in the ATV volumes, Ulmann's Enzyklopädie and other technical literature and technical journals, e.g. Korrespondenz Abwasser, Water Science & Technology, etc., or can be found in the internet and/or are available on the market. Furthermore, process-enhancing additives may be added.

Solids/liquid separation covers all applicable separation processes of liquid and solid materials which can be employed in domestic waste water purification and potable water processing. They include all processes for solids/liquid separation known to a skilled person, such as for instance adsorption, filtration, (see above under filtration), precipitation, centrifugation, sedimentation, membrane processes, etc., which are for instance described in the ATV volumes, Ullman's Enzyklopäedie and other technical literature and technical journals, e.g. Korrespondenz Abwasser, Water Science & Technology, etc., or can be found in the internet and/or are available on the market. Further, process-enhancing additives may be added.

Activated material processes comprise all processes in which microorganisms float freely in the liquid to be treated, such as for instance activated sludge processes, SBR plants etc. They include all processes which are known to a skilled person and which are for instance described in the ATV volumes, Ullman's Enzyklopäedie and other technical literature and technical journals, e.g. Korrespondenz Abwasser, Water Science & Technology, etc., or can be found in the internet and/or are available on the market. Process-enhancing additive may also be added.

Membranes comprise membranes made of all suitable materials being available in the market, eg. Ceramics, with pores of all pore sizes, such as e.g. Reverse Osmosis, Nano, Ultra and Micro-Filtration Membranes, etc. They include all membranes which are known to a skilled person and which are for instance described in the ATV volumes, Ullman's Enzyklopäedie and other technical literature and technical journals, e.g. Korrespondenz Abwasser, Water Science & Technology, etc., or can be found in the internet and/or are available on the market.

Biological Oxidation is the generic term of oxidative fixed bed and/or activated material processes and other nature-resembling processes, such as constructed wetlands, oxidation ponds, etc. It includes all biological oxidation processes that are known to a skilled person, which are for instance described in the ATV volumes, Ullman's Enzyklopäedie and other technical literature and technical journals, e.g. Korrespondenz Abwasser, Water Science & Technology, etc., or can be found in the internet and/or are available on the market. Process-enhancing additive may also be added.

Ureolysis is defined here as the hydrolytic cleavage of urea to CO₂ and ammonia and/or ammonium, which is preferably catalysed enzymatic and especially preferably catalysed by the enzyme urease. This can be executed under aerobic up to strictly anaerobic conditions. In an especially preferred embodiment, ureolytic bacteria (e.g. proteus vulgaris) are immobilised on a carrier material.

Desalination comprises all desalination methods, leading to removal of mono- and/or bivalent cations and/or anions from black, and/or brown, and/or yellow and/or grey water. All different precipitation methods, like struvite precipitation, as well as stripping methods, like NH₃-stripping, etc. drying methods, like MSF, etc., but also filtration methods, such as nano-filtration, reverse osmosis, etc., can be meant here. It includes all technical desalination processes that are known to a skilled person, such as all methods of biological oxidation, which are for instance described in the ATV volumes, Ullman's Enzyklopäedie and other technical literature and technical journals, e.g. Korrespondenz Abwasser, Water Science & Technology, etc., or can be found in the internet and/or are available on the market. Process-enhancing additive may also be added.

Alternatively the term desalination can also comprise a complexation of anions and/or cations

Inorganic salts comprise all salts from mono- and/or bivalent anions and mono- and/or bivalent cations, which increasingly concentrate in the toilet flushing water loop and which are tending to precipitation due to their accumulation, like struvite, sulphate-, carbonate- and phosphourus-salts with preferably bivalent metal ions, like magnesium, calcium, etc. It includes one or more of all nutrient salts preferably from human excrements that are known to a skilled person, as they are described in the ATV volumes, Ullman's Enzyklopäedie and other technical literature and technical journals, e.g. Korrespondenz Abwasser, Water Science and Technology, etc. or can be found in the internet.

Nutrient salts comprise all salts of inorganic salts from mono- and/or bivalent anions and mono- and/or bivalent cations, which increasingly concentrate in the toilet flushing water loop, like salpeter, magnesium phosphate, etc., and which are tending to precipitation due to their accumulation, and which can be disposed crop-increasingly in agriculture for fertilising purposes. It includes one or more of all nutrient salts preferably from human excrements that are known to a skilled person, as they are described in the ATV volumes, Ullman's Enzyklopäedie and other technical literature and technical journals, e.g. Korrespondenz Abwasser, Water Science and Technology, etc. or can be found in the internet, as well as in professional journals and literature of agriculture.

Prevention of incrustation comprises all methods, to prevent an uncontrolled precipitation of mono- and/or bivalent anions and mono- and/or bivalent cations at unwanted locations within the hydraulic way of the brown and/or black water loop process, such as in the treatment plant and/or rising mains and/or flushing water store and/or toilet flushing water feed pipes and/or toilet tanks and/or toilets themselves, and/or the brown- or black water drainage pipes. On the one hand, methods for enhancement of solubility can be meant here such as e.g. complex formation of bivalent cations with amino phosphonic acid and/or pH regulation and/or other chemical and/or physical methods enhancing the solubility of anions and/or cations. On the other hand, methods for specific removal of inorganic salts and/or nutrient salts at wanted locations, for lowering ion concentrations in the toilet flushing water can be meant here, such as precipitations and/or ion exchange and/or sacrificial anodes and/or cathodes, etc. It includes all methods for prevention of precipitation of inorganic salts at unwanted locations that are known to a skilled person, as they are described e.g. in the ATV volumes, Ullman's Enzyklopäedie and other technical literature and technical journals, e.g. Korrespondenz Abwasser, Water Science and Technology, etc. or can be found and be described in the internet.

2. Description of the Problem

In the patent PCT/EP98/03316 a loop-processing of brown or black water is described. Biological treatment causes a release of inorganic salts from organic molecules, like metal ions, phosphates and reduced nitrogen and sulphur ions and biological oxidation oxidises the latter two to nitrite, nitrate and sulphate ions. Due to the loop-process, finally an approximate similar concentration profile is reached, as it is found in human urine.

Thus, within the entire hydraulic way of the loop process, from the treatment plant via rising mains, the flushing water store, the toilet flushing water feed pipes the toilet tanks, the toilets themselves, and the brown- or black water drainage pipes, it can come to precipitations of inorganic salts, which can hinder the entire process and/or disrupt it finally.

Especially on the distance of the loop between toilet and oxidation precipitations can happen, due to the partly high pH values caused by the release of ammonium. Precipitations refer mainly bivalent salts, like MgPO₄, etc. Also struvite often leads to unwanted incrustations. To achieve a specific precipitation of bivalent cations (Mg) as struvite, or to achieve a specific elimination (e.g. stripping) of nitrogen, which occurs mainly as Urea-[N] in urine, nitrogen has to released from urea before.

In de-centralised waste water treatment, toilet waste waters are fresh, meaning there are no long transportation ways via sewerages. In these sewerages biological processes happen, amongst others also urea cleavage by the enzyme Urease, processing urea to CO2 and ammonium. Humans are recognising that by the evaporation of ammonia out of duct covers.

The method and device being presented here refer to the desalination of toilet and/or urinal waste waters, whereas the method comprises the steps urea cleavage, removal of ammonium and reuse of the toilet flushing water for toilet flushing, and these steps are processed preferably in separated devices.

Often in de-centralised waste water treatment similar treatment steps have been established, like they are in centralised waste water treatment:
1. Removal of coarse rejects (rakes, sieves, etc.)
2. Removal of primary sludge (septic tank, dortmund tank, etc.)
3. Biological oxidation (fixed bed, activated sludge, etc.)
4. Removal of secondary sludge (sedimentation, filtration, etc.)

A specific struvite precipitation is not possible with this steps. If the nutrients shall be precipitated as struvite, as described in this invention, the NH₂ contained in urea has to be released and reduced to NH₄⁺ via ureolysis (urea cleavage) before. According to the invention, the step biological oxidation therefore is divided into two steps:
1. Ureolysis
2. Biological oxidation

Then, the by ureolysis released ammonium can be precipitated as struvite in an intermediate step. Also all other methods for ammonium removal (stripping, adsorption with Klinoptilolith, or other zeolites or materials) become now possible and can be employed here.

With the method according to this invention and its exemplary and/or preferred embodiments he described disadvantages of the state-of-the-art are eliminated.

Another problem occurs by loop-processing of toilet flushing water in mobile units. Due to the long retention time in biological oxidation reactors
big volumes have to be transported, and
difficulties of adaption of the biology to peak loads have to be considered

Airplanes have to transport several cubic meters of water on long distances, and dispose it at the arrival airport. This amounts can be remarkably reduced with the method being presented here.

With the method according to this invention and its embodiments the described problems are eliminated.

3. State of the Art

State of the art in sanitary engineering is the linear extraction of drinking water, its use, followed by the waste water disposal in sewerages. Treatment of sewage within the settlement and the following disposal is also state of the art. The concentration of ions within this linear process are so low, that incrustations rarely occur, and if so, only on long-term. Known by the expert skilled in the art are occurring incrustations during de-watering of sewage sludge due to accumulation effects. Also known to the experts is, that anaerobic treatment supports occurrence of incrustations, like struvite.

Known are also methods for loop-processing of toilet flushing water, as described in the patent specifications by Jordan, U.S. Pat. No. 4,904,387, Eger, U.S. Pat. No. 3,950,249 und Braun, PCT/EP98/03316.

According to the patent specifications from Jordan and Eder, an anaerobic de-nitrification is upstream to the biological oxidation. Due to the activity of the enzyme Urease cleaving urea to CO₂ and ammonium and leading to a pH increase, and due to the high concentrations of magnesium and phosphate, massive precipitations of struvite can occur.

In the patent specification by Braun the danger of a struvite precipitation is lower, because on the one hand, a liquid/solids separation is upstream to the biological oxidation decreasing the release of ions into the loop-liquid caused by decomposition of the organic matter, and on the other hand, ammonium is not available for struvite precipitation, because it is oxidised by biological oxidation to nitrate. Additionally, this patent specification provides for a specific struvite precipitation processing yellow water linearly.

However, also in the method of Braun as described in the specification, precipitations of inorganic salts can occur.

In mobile devices, like planes, trains, vessels, etc., as well as in temporary stationary devices, like toilet containers for mass events, black water is collected with water saving devices and stored, and disposed after the mobile or temporary stationary phase. Thus, large amounts of water have to be stored and transported.

With the method and devices according to this invention the disadvantages of the state of the art are eliminated.

4. The Method According to the Invention

The method according to the invention comprises one or more methods for prevention of incrustations by desalination according the definition in chapter 1 of the specification at different steps of the method, as they are described in the cited patent specifications, and/or different methods for loop-processing of toilet flushing water.

Before removal of inorganic ions they have to be released from organic molecules. Due to the meanwhile existing urine separation toilets, draining yellow water undiluted, toilet flushing water can be reused with, or without yellow water.

Accordingly, the method according to the invention in an (especially preferred) embodiment comprises the following steps:
a) Separate collection of the partial streams black water or brown water and yellow water, and
b) Ureolysis of the in (a) separately collected partial streams black water or yellow water, whereby the ureolytic bacteria can be immobilised, and
c) Usage the ureolysed product of (c) for
   (c.i) Collection of black water or brown water in (a), or
   (c.ii) Other usages, and
d) Repeating steps (a) to (c) one or more times

The term “(especially preferred)” respectively “(preferred)” connotes in the context of this invention, that both the corresponding embodiment is, or can be (especially) preferred, as well as that the corresponding embodiment is, or can be an independent embodiment.

The method in another (especially preferred) embodiment comprises the following steps:
(a) Separate collection of the partial streams black water or brown water and yellow water, and
(b) Desalination of at least one of the in (a) separately collected partial streams, whereby the desalination can be a struvite precipitation, and
(c) Usage the desalted liquid phase of (b) for
   (c.i) Collection of black water or brown water in (a), or
   (c.ii) Other usages, and
(d) Repeating steps (a) to (c) one or more times

The method in another (especially preferred) embodiment comprises the following steps:
i) Separate collection of the partial streams black water or brown water and yellow water, and
ii) Uroelysis in the partial streams black water or yellow water from (a), and
iii) Desalination of the products of (b), whereby the desalination can be a struvite precipitation, and
iv) Usage the desalted liquid phase of (c) for
   c.i) Collection of black water or brown water in (a), or
   c.ii) Other usages, and
v) Repeating steps (a) to (d) one or more times

In another, (especially preferred) embodiment of the method according to the invention an intermediate liquid/solids separation step is switched between steps (a) and (b) of the preceding (preferred) embodiments.

In another, (especially preferred) embodiment of the method according to the invention, the method comprises the following steps:
i) Separate collection of the partial streams black water or brown water and yellow water, and
ii) Liquid/solids separation in the partial streams black water and/or brown water from (i), and
iii) Ureolysis of yellow water from (i) and/or the liquid phase of black water from (ii), and
iv) Struvite precipitation in the products of (iii), and
v) Oxidation of the liquid phases of (iv), and
vi) Usage the desalted liquid phase of (v) for
   vi.a) Collection of black water or brown water in (i), or
   vi.b) Other usages, and
vii) Repeating steps (i) to (vi) one or more times

In another (especially preferred) embodiment the method according to the invention comprises a specific prevention of incrustations of nutrient salts by specific removal of said nutrient salts from brown and/or black water liquids according to the definitions in chapter 1 of the specification. Thus, the nutrients can be separated from common salt (NaCl) preventing an accumulation of salts in soils, after further treatment of the nutrients, and/or after direct applying the nutrient salts.

In another (especially preferred) embodiment the method according to the invention comprises a specific prevention of incrustations of phosphate salts by specific removal of said phosphate salts from brown and/or black water liquids according to the definitions in chapter 1 of the specification. Thus, the phosphate salts can be collected in a pure form and a further exploitation of the restricted phosphate resources can be avoided.

In another (especially preferred) embodiment the method according to the invention comprises a specific prevention of incrustations of nitrogen salts by specific removal of said nitrogen salts from brown and/or black water liquids according to the definitions in chapter 1 of the specification. Thus, the nitrogen salts can be collected in a pure form and the energy intense ammonia production according to the Haber-Bosch method can be replaced.

In another (especially preferred) embodiment the method according to the invention comprises a specific prevention of incrustations of the bivalent ions magnesium and/or calcium by specific removal of said bivalent ions magnesium and/or calcium from brown and/or black water liquids according to the definitions in chapter 1 of the specification. Thus, the bivalent ions magnesium and/or calcium can be collected in a pure form and feed into a further utilisation, as well as membranes can be protected against blocking by bivalent salts.

In another (especially preferred) embodiment the method according to the invention comprises a de-central collection of the inorganic salts or nutrient salts according to the definitions in chapter 1 of the specification preferably out of single or several buildings and/or their de-central utilisation according to the (especially preferred) embodiments of the methods according to the invention.

In another (especially preferred) embodiment the method according to the invention comprises a specific prevention of incrustations according to the definitions in chapter 1 of the specification after the drainage pipes of the toilets.

In another (especially preferred) embodiment the method according to the invention comprises a specific prevention of incrustations according to the definitions in chapter 1 of the specification in a partial stream, being separated from the black and/or brown water loop in and/or before a means for transportation of liquids, whereby this partial stream can be reunified with the main stream of the black, or brown water loop after the means for transportation of liquids. It can be a simultaneous, combined step for prevention of incrustations and transport of liquids.

In another (especially preferred) embodiment the method according to the invention comprises a specific prevention of incrustations according to the definitions in chapter 1 of the specification in a partial stream, being separated from the black and/or brown water loop in and/or before a means for liquid/solids separation, whereby this partial stream can be reunified with the main stream of the black, or brown water loop after the means for liquid/solids separation. It can be a simultaneous, combined step for prevention of incrustations and liquid/solids separation.

In another (especially preferred) embodiment the method according to the invention comprises a specific prevention of incrustations according to the definitions in chapter 1 of the specification in a partial stream, being separated from the black and/or brown water loop in and/or before a means for biological oxidation, whereby this partial stream can be reunified with the main stream of the black, or brown water loop after the means for biological oxidation. It can be a simultaneous, combined step for prevention of incrustations and biological oxidation.

In another (especially preferred) embodiment the method according to the invention comprises a specific prevention of incrustations according to the definitions in chapter 1 of the specification in a partial stream, being separated from the black and/or brown water loop in and/or before a means for biological denitrification, whereby this partial stream can be reunified with the main stream of the black, or brown water loop after the means for biological denitrification. It can be a simultaneous, combined step for prevention of incrustations and biological denitrification.

In another (especially preferred) embodiment the method according to the invention comprises a specific prevention of incrustations according to the definitions in chapter 1 of the specification in a partial stream, being separated from the black and/or brown water loop in and/or before a means for ozonisation, whereby this partial stream can be reunified with the main stream of the black, or brown water loop after the means for ozonisation. It can be a simultaneous, combined step for prevention of incrustations and ozonisation.

In another (especially preferred) embodiment the method according to the invention comprises a specific prevention of incrustations according to the definitions in chapter 1 of the specification in a partial stream, being separated from the black and/or brown water loop in and/or before a means for adsorption, preferably with activated carbon, whereby this partial stream can be reunified with the main stream of the black, or brown water loop after the means for adsorption. It can be a simultaneous, combined step for prevention of incrustations and adsorption.

In another (especially preferred) embodiment the method according to the invention comprises a specific prevention of incrustations according to the definitions in chapter 1 of the specification in a partial stream, being separated from the black and/or brown water loop in and/or before a means for hydrolysis, whereby this partial stream can be reunified with the main stream of the black, or brown water loop after the means for hydrolysis. It can be a simultaneous, combined step for prevention of incrustations and hydrolysis.

In another (especially preferred) embodiment the method according to the invention comprises a specific prevention of incrustations according to the definitions in chapter 1 of the specification in a partial stream, being separated from the black and/or brown water loop in and/or before a means for methane fermentation, whereby this partial stream can be reunified with the main stream of the black, or brown water loop after the means for methane fermentation. It can be a simultaneous, combined step for prevention of incrustations and methane fermentation.

In another (especially preferred) embodiment the method according to the invention comprises a specific prevention of incrustations according to the definitions in chapter 1 of the specification in a partial stream, being separated from the black and/or brown water loop in and/or before a means for hygienisation, preferably with UV radiation, whereby this partial stream can be reunified with the main stream of the black, or brown water loop after the means for hygienisation. It can be a simultaneous, combined step for prevention of incrustations and hygienisation.

In another (especially preferred) embodiment the method according to the invention comprises the following steps:
(a) Separate collection of the partial streams grey water, or one, or more partial streams thereof and black water, or brown water and yellow water, and
(b) First desalination of the separately, in (a) collected partial streams of black, or brown water and/or yellow water separately collected in (a), and
(c) Second desalination of the products of (b), and
(d) Usage the desalted liquid phase of (c) for collection of black water or brown water, and
(e) Repeating steps (a) to (d) one or more times

In another (especially preferred) embodiment the method according to the invention comprises the following steps:
(i) Separate collection of the partial streams grey water, or one, or more partial streams thereof and black water, or brown water and yellow water, and
(ii) Desalination of the separately, in (i) collected partial streams of black, or brown water and/or yellow water separately collected in (i), and
(iii) Oxidation of one of from (ii) resulting low salt containing phases from black and/or brown water, and
(iv) Usage the desalted liquid phase of (iii) for collection of black water or brown water, and
(v) Repeating steps (i) to (iv) one or more times

In another (especially preferred) embodiment the method according to the invention comprises the following steps:
(I) Separate collection of the partial streams grey water, or one, or more partial streams thereof and black water, or brown water and yellow water, and
(II) Oxidation of at least one of the separately, in (I) collected partial streams of black, or brown water, and
(III) Liquid/solids separation of at least one of the products of (II) from black and/or brown water, and
(IV) UV-Oxidation of the liquid phase of at least one of the products from (III) from black and/or brown water, and
(V) Usage the desalted liquid phase of (IV) for collection of black water or brown water, and
(VI) Repeating steps (I) to (V) one or more times

In another (especially preferred) embodiment the method according to the invention comprises the following steps:
(A) Separate collection of the partial streams grey water, or one, or more partial streams thereof and black water, or brown water and yellow water, and
(B) Removal of carbon in at least one of the separately, in (A) collected partial streams of grey water, and
(C) Membrane filtration in the liquid phases obtained from (B) from grey water, or one, or more of its partial streams, and
(D) Desalination of at least one of the liquid phases obtained in (C), and
(E) Oxidation of at least one of the liquid phases obtained in (D), and
(F) Usage of the liquid phase of (E) for collection of grey water, or one, or more of its partial streams, and
(G) Repeating steps (A) to (F) one or more times

In another (especially preferred) embodiment of the method according to the invention the steps comprise after the steps (b), (ii) and (II) a membrane filtration of grey water, or one, or more of its partial streams, as a additional step (bi), (iia) and (IIa).

In another (especially preferred) embodiment of the method according to the invention the steps comprise after the steps (B) a membrane filtration of grey water, or one, or more of its partial streams thereof, as a additional step (Ba).

In another (especially preferred) embodiment of the method according to the invention, the steps (b), (ii), (C) and (II) are an ultra or nano filtration.

In another (especially preferred) embodiment of the method according to the invention, the steps (c) and (iii) a struvite precipitation.

In another (especially preferred) embodiment of the method according to the invention, a metered addition of substances in liquid or solid form is proceeded between the steps (c) and (b), as well as (iii) and (ii).

In another (especially preferred) embodiment of the method according to the invention, the dosed substances comprise MgO and/or Mg(OH)2. and/or phosphor compounds.

In another (especially preferred) embodiment of the method according to the invention, the metered addition is proceeded stoichiometrical amounts, being calculated basing on the concentrations of ammonium in the liquid to be treated.

In another (especially preferred) embodiment of the method according to the invention, the steps (d) and (iii) is a reverse osmosis.

In another (especially preferred) embodiment of the method according to the invention, steps (c) and (b), as well as the steps (iii) and (ii) are proceeded in one vessel, or in two, hydraulically not separates vessels.

In another (especially preferred) embodiment of the method according to the invention, the metered addition of substances between steps (c), and (b) is proceeded according to that amount of ammonium, which is necessary, to render the equalisation of the pH decrease, caused by the transformation of ammonium to nitrate, in the oxidation step (d) possible, which neutralises the basic milieu of the discharge of step (c).

In another (especially preferred) embodiment of the method according to the invention, the pH decrease in step (iv) is proceeded by addition of anions.

In another (especially preferred) embodiment of the method according to the invention, the anions comprise nitrate.

In another (especially preferred) embodiment of the method according to the invention, step (e) is an adsorption with activated carbon and/or an ozonisation and/or an UV treatment.

In another (especially preferred) embodiment of the method according to the invention, step (V) is an UVC treatment and/or an ozonisation.

In another (especially preferred) embodiment of the method according to the invention, step (iii) is not a desalination, but a complexation with a complex-forming substance.

In another (especially preferred) embodiment of the method according to the invention, the complexation substance comprises amino phosphonic acid.

In another (especially preferred) embodiment of the method according to the invention, the complex-forming substance can be added at every step before step (v).

In another (especially preferred) embodiment the method according to the invention comprises the following steps:
(one) drainage of an aqueous liquid fro a storage tank, and
(two) usage of this liquid for toilet flushing, which can comprise the collection of faeces and urine, and
(three) treatment of this liquid, and
(four) feeding this liquid into said storage tank, and
(five) UVC treatment of this liquid In said storage tank, and
(six) Repeating steps (one) to (five) one or more times

The method in another (especially preferred) embodiment comprises the following steps:
(firstly) drainage of an aqueous liquid fro a storage tank, and
(secondly) treatment of this liquid, and
(thirdly) usage of this liquid for toilet flushing, which can comprise the collection of faeces and urine, and
(fourthly) treatment of this liquid, and
(fifthly) feeding this liquid into said storage tank, and
(sixthly) increase of the pH value in said storage tank, or in a tank parallel to the storage tank, and
(seventh) Repeating steps (firstly) to (sixthly) one or more times

5. The Device According to the Invention

The device according to the invention comprises one or more means for prevention of incrustations according to the definition in chapter 1 of this specification in and/or before and/or after the different devices of the methods being described in the patent specifications being cited above, and/or devices of other methods for loop-processing of toilet flushing water.

The device according to the invention in an (especially preferred) embodiment comprises the following means:
(A) Means for separate collection of the partial streams black water or brown water and yellow water, and
(B) Means for urea cleavage of the separately collected partial streams black water or yellow water from (A), and
(C) Means for struvite precipitation in the products of (B) for
(D) Means for usage of the liquid phase from (C) for
   (D.a) Collection of black water or brown water in (A), or
   (D.b) Other usages, and

The device in another (especially preferred) embodiment according to the invention comprises a means for repeating step (A) to (D) one or more times.

In another (especially preferred) embodiment of the device according to the invention it comprises the following means:
(I) Means for separate collection of the partial streams black water or brown water and yellow water, and
(II) Means for liquid/solids separation of black water and or brown water separately collected in (I), and
(III) Means for cleavage of urea in partial streams yellow water from (I), and/or the liquid phase from black water of (II), and
(IV) Means for struvite precipitation the products if (III), and
(V) Means for oxidation of the liquid phases from (IV), and
(VI) Means for usage of the liquid phase of (V) for
   (VI.a) Collection of black water or brown water in (I), or
   (VI.b) Other usages, and
(VII) Means for repeating steps (I) to (VI) one or more times

In another (especially preferred) embodiment the device according to the invention comprises a means for a specific prevention of incrustations according to the definitions in chapter 1 of the specification in a partial stream, being separated from the black and/or brown water loop in and/or before a means for transportation of liquids, whereby this partial stream can be reunified with the main stream of the black, or brown water loop after the means for transportation of liquids, and/or a simultaneous, combined step for prevention of incrustations and transport of liquids.

In another (especially preferred) embodiment the device according to the invention comprises a means for a specific prevention of incrustations according to the definitions in chapter 1 of the specification in a partial stream, being separated from the black and/or brown water loop in and/or before a means for liquid/solids separation, whereby this partial stream can be reunified with the main stream of the black, or brown water loop after the means for liquid/solids separation, and/or a simultaneous, combined step for prevention of incrustations and liquid/solids separation.

In another (especially preferred) embodiment the device according to the invention comprises a means for a specific prevention of incrustations according to the definitions in chapter 1 of the specification in a partial stream, being separated from the black and/or brown water loop in and/or before a means for biological oxidation, whereby this partial stream can be reunified with the main stream of the black, or brown water loop after the means for biological oxidation, and/or a simultaneous, combined step for prevention of incrustations and biological oxidation.

In another (especially preferred) embodiment the device according to the invention comprises a means for a specific prevention of incrustations according to the definitions in chapter 1 of the specification in a partial stream, being separated from the black and/or brown water loop in and/or before a means for biological denitrification, whereby this partial stream can be reunified with the main stream of the black, or brown water loop after the means for biological denitrification, and/or a simultaneous, combined step for prevention of incrustations and biological denitrification.

In another (especially preferred) embodiment the device according to the invention comprises a means for a specific prevention of incrustations according to the definitions in chapter 1 of the specification in a partial stream, being separated from the black and/or brown water loop in and/or before a means for ozonisation, whereby this partial stream can be reunified with the main stream of the black, or brown water loop after the means for ozonisation, and/or a simultaneous, combined step for prevention of incrustations and ozonisation.

In another (especially preferred) embodiment the device according to the invention comprises a means for a specific prevention of incrustations according to the definitions in chapter 1 of the specification in a partial stream, being separated from the black and/or brown water loop in and/or before a means for adsorption, preferably with activated carbon, whereby this partial stream can be reunified with the main stream of the black, or brown water loop after the means for adsorption, and/or a simultaneous, combined step for prevention of incrustations and adsorption.

In another (especially preferred) embodiment the device according to the invention comprises a means for a specific prevention of incrustations according to the definitions in chapter 1 of the specification In a partial stream, being separated from the black and/or brown water loop in and/or before a means for hygienisation, preferably with UV radiation, whereby this partial stream can be reunified with the main stream of the black, or brown water loop after the means for hygienisation, and/or a simultaneous, combined step for prevention of incrustations and hygienisation.

In another (especially preferred) embodiment the device according to the invention comprises a means for a specific prevention of Incrustations according to the definitions in chapter 1 of the specification in a partial stream, being separated from the black and/or brown water loop In and/or before a means for hydrolysis, whereby this partial stream can be reunified with the main stream of the black, or brown water loop after the means for hydrolysis, and/or a simultaneous, combined step for prevention of incrustations and hydrolysis.

In another (especially preferred) embodiment the device according to the invention comprises a means for a specific prevention of incrustations according to the definitions in chapter 1 of the specification in a partial stream, being separated from the black and/or brown water loop in and/or before a means for methane fermentation, whereby this partial stream can be reunified with the main stream of the black, or brown water loop after the means for methane fermentation, and/or a simultaneous, combined step for prevention of incrustations and methane fermentation.

In another (especially preferred) embodiment of the device according to the invention it comprises the following means:
(a) Means for a separate collection of the partial streams grey water, or one, or more partial streams thereof and black water, or brown water and yellow water, and
(b) Means for a liquid/solid separation of the separately in (a) collected partial streams black water and/or brown water, and
(c) Means for a first desalination of the separately, in (b) obtained liquid phases of black, or brown water and/or yellow water separately collected in (a), and
(d) Means for a second desalination of the liquid phases obtained in (b), and
(e) Means for a oxidation of at least one of the low salt containing liquid phases of black and/or brown water obtained in (d)
(f) Means for an usage of the liquid phase of (e) for collection of black water or brown water, and
(g) Repeating steps (a) to (f) one or more times

In another (especially preferred) embodiment of the device according to the invention it comprises the following means:
(i) Means for a separate collection of the partial streams grey water, or one, or more partial streams thereof and black water, or brown water and yellow water, and
(ii) Means for a liquid/solid separation of the separately in (i) collected partial streams black water and/or brown water, and
(iii) Means for a desalination of the separately, in (ii) collected liquid phases of black, or brown water and/or yellow water separately collected in (i), and
(iv) Means for a oxidation of one of from (iii) resulting low salt containing phases from black and/or brown water, and
(v) Means for a usage the liquid phase of (iv) for collection of black water or brown water, and
(vi) Repeating steps (i) to (iv) one or more times

In another (especially preferred) embodiment of the device according to the invention it comprises the following means:
(I) Means for a separate collection of the partial streams grey water, or one, or more partial streams thereof and black water, or brown water and yellow water, and
(II) Means for a liquid/solids separation of the separately in (I) collected partial streams black water and/or brown water
(III) Means for a oxidation of at least one of the liquid phases of black water, or brown water
(IV) Means for a liquid/solids separation of at least one of the products of (III) from separately collected black and/or brown water, and
(V) Means for a UV-Oxidation of the liquid phase of at least one of the products from (IV) from separately collected black and/or brown water, and
(VI) Means for a usage the liquid phase of (V) for collection of black water or brown water, and
(VII) Means for a repeating steps (I) to (VI) one or more times

In another (especially preferred) embodiment of the device according to the invention it comprises the following means:
(A) Means for a separate collection of the partial streams grey water, or one, or more partial streams thereof and black water, or brown water and yellow water, and
(B) Means for a removal of carbon in at least one of the separately, in (A) collected partial streams of grey water, and
(C) Means for a membrane filtration in the liquid phases obtained from (B) from grey water, or one, or more of its partial streams thereof, and
(D) Means for a desalination of at least one of the liquid phases obtained in (C), and
(E) Means for a oxidation of at least one of the low salt liquid phases obtained in (D), and
(F) Means for a usage of the liquid phase of (E) for collection of grey water, or one, or more of its partial streams, and
(G) Means for a repeating steps (A) to (F) one or more times

In another (especially preferred) embodiment of the device according to the invention the means comprise after the means (b), (ii) and (II) a means for membrane filtration of grey water, or one, or more of its partial streams, as a additional means (bi), (iia) and (IIa).

In another (especially preferred) embodiment of the device according to the invention the means comprise after the means (B) a means for loop-processing of the in (A) separately collected black water or brown water, with, or without yellow water, as additional means (Ba).

In another (especially preferred) embodiment of the device, according to the invention, comprises a means for intermediate storage of black and/or brown water comprising the means as follows:
(one) Means for a drainage of an aqueous liquid from a storage tank, and
(two) Means for a usage of this liquid for toilet flushing, which can comprise the collection of faeces and urine, and
(three) Means for a treatment of this liquid, and
(four) Means for a feeding this liquid into said storage tank, and
(five) Means for a UVC treatment of this liquid in said storage tank, and
(six) Means for a repeating steps (one) to (five) one or more times

In another (especially preferred) embodiment of the device, according to the invention, comprises a means for intermediate storage of black and/or brown water comprising the means as follows:
(firstly) Means for a drainage of an aqueous liquid from a storage tank, and
(secondly) Means for a treatment of this liquid, and
(thirdly) Means for a usage of this liquid for toilet flushing, which can comprise the collection of faeces and/or urine, and
(fourthly) Means for a treatment of this liquid, and
(fifthly) Means for a feeding this liquid into the storage tank, and
(sixthly) Means for a increase of the pH value in said storage tank, or in a tank parallel to the storage tank, and
(seventh) Means for a repeating steps (firstly) to (sixthly) one or more times

Furthermore, the invention is characterised by the embodiments as follows:

A method for treatment and loop-processing of waste waters comprising the steps as follows:
(a) separate collection of the partial streams grey water, or one, or more partial streams thereof and black water, or brown water and yellow water, and
(b) liquid/solid separation of the separately in (a) collected partial streams black water and/or brown water, and
(c) a first desalination of the separately, in (b) obtained liquid phases of black, or brown water and/or yellow water separately collected in (a), and
(d) a second desalination of the liquid phases obtained in (c), and
(e) oxidation of at least one of the low salt containing liquid phases of black and/or brown water obtained in (d)
(f) usage of the liquid phase of (e) for collection of black water or brown water, and
(g) Repeating steps (a) to (f) one or more times

A method for treatment and loop-processing of waste waters comprising the steps as follows:
(a) separate collection of the partial streams grey water, or one, or more partial streams thereof and black water, or brown water and yellow water, and
(b) liquid/solid separation of the separately in (a) collected partial streams black water and/or brown water, and
(c) desalination of the separately, in (b) collected liquid phases of black, or brown water and/or yellow water separately collected in (a), and
(d) oxidation of at least one of from (c) resulting low salt containing phases from black and/or brown water, and
(e) usage the liquid phase of (d) for collection of black water or brown water, and
(f) Repeating steps (a) to (e) one or more times

A method for treatment and loop-processing of waste waters comprising the steps as follows:
(a) separate collection of the partial streams grey water, or one, or more partial streams thereof and black water, or brown water and yellow water, and
(b) liquid/solids separation of the separately in (a) collected partial streams of black and/or brown water
(c) oxidation of at least one of the liquid phases obtained in (b) of black, or brown water, and
(d) liquid/solids separation of at least one of the products of (c) from separately collected black and/or brown water, and
(e) UV-Oxidation of the liquid phase of at least one of the products from (d) from separately collected black and/or brown water, and
(f) usage the liquid phase of (e) for collection of black water or brown water, and
(g) repeating steps (a) to (f) one or more times

A method for treatment and loop-processing of waste waters comprising the steps as follows:
(a) separate collection of the partial streams grey water, or one, or more partial streams thereof and black water, or brown water and yellow water, and
(b) removal of carbon in at least one of the separately, in (a) collected partial streams of grey water, and
(c) membrane filtration in the liquid phases obtained from (b) from grey water, or one, or more of its partial streams thereof, and
(d) desalination of at least one of the liquid phases obtained in (c), and
(e) oxidation of at least one of the low salt liquid phases obtained in (d), and
(f) usage of the liquid phase of (e) for collection of grey water, or one, or more of its partial streams, and
(g) repeating steps (a) to (f) one or more times

A (preferred) method, whereas above described step (b) is a ultra or nano filtration.

A (preferred) method, whereas the above described step (c) is a struvite precipitation.

A (preferred) method, whereas between the above described steps (c) and (d) a metered addition of substances in solid or liquid form.

A (preferred) method, whereas the above mentioned metered additions comprise the substances MgO and/or Mg(OH)2 and/or phosphorous.

A (preferred) method, whereas the above described metered addition is proceeded with stoichiometric amounts being adapted to the concentrations of ammonium within the liquid to be treated.

A (preferred) method, whereas the above described second desalination in step (d) is a reverse osmosis.

A (preferred) method, whereas the above described steps (c) and (d) are executed in one holding tank, or in two hydraulically not separated holding tanks.

A (preferred) method, whereas the metered addition of substances is proceeded according to that amount of ammonium, which is necessary, to render the equalisation of the pH decrease, caused by the transformation of ammonium to nitrate, in the oxidation step (d) possible, which neutralises the basic milieu of the discharge of step (c).

A (preferred) method, whereas the pH decrease in step (d) is executed with addition of anions.

A (preferred) method, whereas the anions mentioned above comprise nitrate.

A (preferred) method, whereas the above described step (e) is a activated carbon adsorption and/or ozonisation and/or UV treatment.

A (preferred) method, whereas the above described step (e) is a UVC treatment and/or ozonisation.

A (preferred) method, whereas the above described desalination in (c) is not a desalination, but a complexation of bivalent ions with a complex-forming agent.

A (preferred) method, whereas the above described complex-forming agent is amino phosphonic acid.

A (preferred) method, whereas the above described complex-forming agent can be added at every step before step (e).

A method for treatment and loop-processing of waste waters comprising the steps as follows:
(a) separate collection of the partial streams grey water, or one, or more partial streams thereof and black water, or brown water and yellow water, and
(b) liquid/solid separation of the separately in (a) collected partial streams black water and/or brown water, and
   (bi) membrane filtration of the in (a) separate collected grey water, or one, or more partial streams thereof, and
(c) first desalination of the separately, in (b) obtained liquid phases of black, or brown water and/or yellow water separately collected in (a), and
(d) second desalination of the liquid phases obtained in (c), and
(e) oxidation of at least one of the low salt containing liquid phases of black and/or brown water obtained in (d)
(f) usage of the liquid phase of (e) for collection of black water or brown water, and
(g) Repeating steps (a) to (f) one or more times

A method for treatment and loop-processing of waste waters comprising the steps as follows:
(a) separate collection of the partial streams grey water, or one, or more partial streams thereof and black water, or brown water and yellow water, and
(b) liquid/solid separation of the separately in (a) collected partial streams black water and/or brown water, and
   (bi) membrane filtration of the in (a) separate collected grey water, or one, or more partial streams thereof, and
(c) desalination of the separately, in (b) collected liquid phases of black, or brown water and/or yellow water separately collected in (a), and
(d) oxidation of one of from (c) resulting low salt containing phases from black and/or brown water, and
(e) usage the liquid phase of (d) for collection of black water or brown water, and
(f) Repeating steps (a) to (e) one or more times

A method for treatment and loop-processing of waste waters comprising the steps as follows:
(a) separate collection of the partial streams grey water, or one, or more partial streams thereof and black water, or brown water and yellow water, and
(b) liquid/solids separation of the separately in (a) collected liquid phases of separate collected partial streams black water and/or brown water
   (bi) membrane filtration of the in (a) separate collected grey water, or one, or more partial streams thereof, and
(c) oxidation of at least one of the liquid phases of black, or brown water obtained in (b), and
(d) liquid/solids separation of at least one of the products of (c) from separately collected black and/or brown water, and
(e) UV-Oxidation of the liquid phase of at least one of the products from (d) from separately collected black and/or brown water, and
(f) usage the liquid phase of (e) for collection of black water or brown water, and
(g) repeating steps (a) to (f) one or more times

A method for treatment and loop-processing of waste waters comprising the steps as follows:
(a) separate collection of the partial streams grey water, or one, or more partial streams thereof and black water, or brown water and yellow water, and
(b) removal of carbon in at least one of the separately, in (a) collected partial streams of grey water, and
   (bi) loop-processing of separately in (a) collected black water or brown water with, or without yellow water, and
(c) membrane filtration in the liquid phases obtained from (b) from grey water, or one, or more of its partial streams thereof, and
(d) desalination of at least one of the liquid phases obtained in (c), and
(e) oxidation of at least one of the low salt liquid phases obtained in (d), and
(f) usage of the liquid phase of (e) for collection of grey water, or one, or more of its partial streams, and
(g) repeating steps (a) to (f) one or more times

A method for intermediate storage of black and/or brown water comprising the following steps:
(a) drainage of an aqueous liquid fro a storage tank, and
(b) usage of this liquid for toilet flushing, which can comprise the collection of faeces and urine, and
(c) treatment of this liquid, and
(d) feeding this liquid into said storage tank, and
(e) UVC treatment of this liquid in said storage tank, and
(f) repeating steps (a) to (e) one or more times.

A method for intermediate storage of black and/or brown water comprising the following steps:
(a) drainage of an aqueous liquid from a storage tank, and
(b) treatment of this liquid, and
(c) usage of this liquid for toilet flushing, which can comprise the collection of faeces and urine, and
(d) treatment of this liquid, and
(e) feeding this liquid into said storage tank, and
(f) increase of the pH value in said storage tank, or in a tank parallel to the storage tank, and
(g) Repeating steps (a) to (f) one or more times

A device for treatment and loop-processing of waste waters comprising the steps as follows:
a) Means for a separate collection of the partial streams grey water, or one, or more partial streams thereof and black water, or brown water and yellow water, and
b) Means for a liquid/solid separation of the separately in (a) collected partial streams black water and/or brown water, and
   (bi) Means for membrane filtration of the in (a) separate collected grey water, or one, or more partial streams thereof, and
c) Means for a first desalination of the separately, in (b) obtained liquid phases of black, or brown water and/or yellow water separately collected in (a), and
d) Means for a second desalination of the liquid phases obtained in (c), and
e) Means for a oxidation of at least one of the low salt containing liquid phases of black and/or brown water obtained in (d), and
f) Means for an usage of the liquid phase of (e) for collection of black water or brown water, and
g) Repeating steps (a) to (f) one or more times

A device for treatment and loop-processing of waste waters comprising the steps as follows:
(a) Means for a separate collection of the partial streams grey water, or one, or more partial streams thereof and black water, or brown water and yellow water, and
(b) Means for a liquid/solid separation of the separately in (a) collected partial streams black water and/or brown water, and
   (bi) Means for membrane filtration of the in (a) separate collected grey water, or one, or more partial streams thereof, and
(c) Means for a desalination of the separately, in (b) collected liquid phases of black, or brown water and/or yellow water separately collected in (a), and
(d) Means for a oxidation of at least one of from (c) resulting low salt containing phases from black and/or brown water, and
(e) Means for a usage the liquid phase of (d) for collection of black water or brown water, and
(f) Repeating steps (a) to (e) one or more times

A device for treatment and loop-processing of waste waters comprising the steps as follows:
(a) Means for a separate collection of the partial streams grey water, or one, or more partial streams thereof and black water, or brown water and yellow water, and
(b) Means for a liquid/solids separation of the separately in (a) collected liquid phases of separate collected partial streams black water and/or brown water
   (bi) Means for membrane filtration of the in (a) separate collected grey water, or one, or more partial streams thereof, and
(c) Means for a oxidation of at least one of the liquid phases of black, or brown water obtained in (b), and
(d) Means for a liquid/solids separation of at least one of the products of (c) from separately collected black and/or brown water, and
(e) Means for a UV-Oxidation of the liquid phase of at least one of the products from (d) from separately collected black and/or brown water, and
(f) Means for a usage the liquid phase of (e) for collection of black water or brown water, and
(g) Means for a repeating steps (a) to (f) one or more times

A device for treatment and loop-processing of waste waters comprising the steps as follows:
(a) Means for a separate collection of the partial streams grey water, or one, or more partial streams thereof and black water, or brown water and yellow water, and
(b) Means for a removal of carbon in at least one of the separately, in (a) collected partial streams of grey water, and
   (bi) Means for membrane filtration of the in (a) separate collected grey water, or one, or more partial streams thereof, and
(c) Means for a membrane filtration in the liquid phases obtained from (b) from grey water, or one, or more of its partial streams thereof, and
(d) Means for a desalination of at least one of the liquid phases obtained in (c), and
(e) Means for a oxidation of at least one of the low salt liquid phases obtained in (d), and
(f) Means for a usage of the liquid phase of (e) for collection of grey water, or one, or more of its partial streams thereof, and
(g) Means for a repeating steps (a) to (f) one or more times

A device for treatment and loop-processing of waste waters comprising the steps as follows:
(a) Means for a separate collection of the partial streams grey water, or one, or more partial streams thereof and black water, or brown water and yellow water, and
(b) Means for a liquid/solid separation of the separately in (a) collected partial streams black water and/or brown water, and
(c) Means for a first desalination of the separately, in (b) obtained liquid phases of black, or brown water and/or yellow water separately collected in (a), and
(d) Means for a second desalination of the liquid phases obtained in (c), and
(e) Means for a oxidation of at least one of the low salt containing liquid phases of black and/or brown water obtained in (d)
(f) Means for an usage of the liquid phase of (e) for collection of black water or brown water, and
(g) Means for repeating steps (a) to (f) one or more times

A device for treatment and loop-processing of waste waters comprising the steps as follows:
(a) Means for a separate collection of the partial streams grey water, or one, or more partial streams thereof and black water, or brown water and yellow water, and
(b) Means for a liquid/solid separation of the separately in (a) collected partial streams black water and/or brown water, and
(c) Means for a desalination of the separately, in (b) collected liquid phases of black, or brown water and/or yellow water separately collected in (a), and
(d) Means for a oxidation of one of from (c) resulting low salt containing phases from black and/or brown water, and
(e) Means for a usage the liquid phase of (d) for collection of black water or brown water, and
(f) Repeating steps (a) to (e) one or more times

A device for treatment and loop-processing of waste waters comprising the steps as follows:
(a) Means for a separate collection of the partial streams grey water, or one, or more partial streams thereof and black water, or brown water and yellow water, and
(b) Means for a liquid/solids separation of the separately in (a) collected liquid phases of black water and/or brown water
(c) Means for oxidation of at least one of the liquid phases obtained in (b) of black, and/or brown water, and
(d) Means for a liquid/solids separation of at least one of the products of (c) from separately collected black and/or brown water, and
(e) Means for a UV-Oxidation of the liquid phase of at least one of the products from (d) from separately collected black and/or brown water, and
(f) Means for a usage the liquid phase of (e) for collection of black water or brown water, and
(g) Means for a repeating steps (a) to (f) one or more times

A device for treatment and loop-processing of waste waters comprising the steps as follows:
(a) Means for a separate collection of the partial streams grey water, or one, or more partial streams thereof and black water, or brown water and yellow water, and
(b) Means for a removal of carbon in at least one of the separately, in (a) collected partial streams of grey water, and
(c) Means for a membrane filtration in the liquid phases obtained from (b) from grey water, or one, or more of its partial streams thereof, and
(d) Means for a desalination of at least one of the liquid phases obtained in (c), and
(e) Means for a oxidation of at least one of the low salt liquid phases obtained in (d), and
(f) Means for a usage of the liquid phase of (e) for collection of grey water, or one, or more of its partial streams, and
(g) Means for a repeating steps (a) to (f) one or more times

A means for intermediate storage of black and/or brown water comprising the following steps:
(a) Means for drainage of an aqueous liquid from a storage tank, and
(b) Means for usage of this liquid for toilet flushing, which can comprise the collection of faeces and urine, and
(c) Means for treatment of this liquid, and
(d) Means for feeding this liquid into the storage tank, and
(e) Means for UVC treatment of this liquid in the storage tank, and
(f) Means for repeating steps (a) to (e) one or more times.

A means for intermediate storage of black and/or brown water comprising the following steps:
(a) Means for drainage of an aqueous liquid from a storage tank, and
(b) Means for treatment of this liquid, and
(c) Means for usage of this liquid for toilet flushing, which can comprise the collection of faeces and urine, and
(d) Means for treatment of this liquid, and
(e) Means for feeding this liquid into the storage tank, and
(f) Means for increase of the pH value in the storage tank, or in a tank parallel to the storage tank, and
(g) Means for repeating steps (a) to (f) one or more times

Furthermore, the invention refers in another embodiment a method for extraction of nutrients form waste waters comprising the following steps:
(a) Separate collecting the partial streams black water or brown water and yellow water, and
(b) Urea cleavage in the partial streams black water and yellow water obtained in (a), and
(c) Removal of nitrogen from the products of (b), and
(d) Usage of the liquid phase from (c) for
   (d.i) Collecting of black water or brown water in (a), or
   (d.ii) Other usages, and

Preferably, the method is characterised, that after step (d) a one, or repeated repetition of step (a) to (d) is executed.

Further preferred is a method, whereas the removal of nitrogen is a struvite precipitation, stripping or an adsorption.

An alternative embodiment relates to a method for treatment and loop-processing of waste waters comprising the following steps:
(a) Separate collecting the partial streams black water and/or brown water and yellow water, and
(b) Liquid/solids separation of the in (a) separate collected the partial streams black water and/or brown water, and
(c) Urea cleavage in the partial streams yellow water obtained in (a) and/or the liquid phase of black water from (b), and
(d) Struvite precipitation in the products from (c), and
(e) Oxidation of the liquid phases from (d), and
(f) Usage of the liquid phase from (e) for
   (f.i) Collecting of black water or brown water in (a), or
   (f.ii) Other usages, and
(g) One, or more fold repetition of the steps (a) to (f)

Preferably the method is characterised, that the struvite precipitation is a stripping, or an adsorption.

Alternatively, the invention refers in another embodiment a device for extraction of nutrients form waste waters comprising the following means:
(a) Means for separate collecting the partial streams black water or brown water and yellow water, and
(b) Means for urea cleavage in the partial streams black water and yellow water obtained in (a), and
(c) Means for struvite precipitation from the products of (b), and
(d) Means for usage of the liquid phase from (e) for
   (d.i) Means for collecting of black water or brown water in (a), or
   (d.ii) Means for other usages, and

Preferably, the device is characterised by the device comprising a means for repetition of step (a) to (d) once or several times.

An alternative embodiment relates to a device for treatment and loop-processing of waste waters comprising the following means:
(a) Means for separate collecting the partial streams black water or brown water and yellow water, and
(b) Means for liquid/solids separation of the in (a) separate collected the partial streams black water or brown water, and
(c) Means for urea cleavage in the partial streams yellow water obtained in (a) and/or black water from (b), and
(d) Means for struvite precipitation in the products from (c), and
(e) Means for oxidation of the liquid phases from (d), and
(f) Means for usage of the liquid phase from (e) for
   (d.iii) Means for collecting of black water or brown water in (a), or
   (d.iv) Means for other usages, and
(g) Means for one, or more fold repetition of the steps (a) to (f)

Particularly, the invention Is characterised by the embodiments as follows:

A method for treatment and loop-processing of waste waters comprising the steps as follows:
(a) separate collection of the partial streams grey water, or one or more of the partial streams thereof and black water or brown water and yellow water, and
(b) desalination of a part or total parts of at least one of the separated collected partial streams of (a), and
(c) reuse of the desalinated liquid phase of (b) to
   (c.i) collection of black water or brown water and/or yellow water in (a), or
   (c.ii) other uses, and
(d) repetition of the steps (a) to (c) one or more times.

Preferably, the desalination in (b) comprises an ureolysis.

Furthermore preferred the desalination in step (b) comprises the following steps:
(b.a) ureolysis, and
(b.b) removal of the nutrient salts.

Additionally preferred is a method, whereas the desalination in step (b), as well as the removal of nutrient salts of in step (b.b) is a struvite precipitation.

Additionally preferred is a method, whereas after the desalination in step (b) the following step is proceeded:
(c) second desalination

Preferably, the second desalination comprises the univalent inorganic salts.

Additionally preferred is a method, whereas before step (b) the following step is proceeded:
(a.i) liquid/solids separation of the separate collected partial streams black and/or brown water obtained in (a)

Additionally preferred is a method, whereas after step (b) the following step is proceeded:
(b.i) oxidation of at least one of in (b) obtained low-salt phases from separate collected black water and/or brown water.

Additionally preferred is a method, whereas after step (b.i) the following step is proceeded:
(b.ii) liquid/solids separation of at least one of the products of (b.i) of separate collected black water and/or brown water

Additionally preferred is a method, whereas after step (b.ii) the following step is proceeded:
(b.iii) UV-Oxidation of the liquid phase of at least one of the products of (b.ii) from separate collected black water and/or brown water

Additionally preferred is a method, whereas step (b) is a ultra or nano filtration

Additionally preferred is a method, whereas between means (b.a) and (b.b) a means for metered addition of substances in solid or liquid form.

Additionally preferred is a method, whereas the means for metered addition comprises the alkali KOH, and/or the substances Mg(CH₃COO)₂ and/or Mg(COO)₂ and/or potassium phosphate compounds with, and/or without hydrogen.

Additionally preferred is a method, whereas the means for metered addition is proceeded with stoichiometric amounts being adapted to the concentrations of ammonium within the liquid to be treated.

Additionally preferred is a method, whereas the means for metered addition is controlled by that amount of ammonium, which is necessary, to render the pH decrease possible, which is caused by the transformation of ammonium to nitrate, in the oxidation means (b.i), which neutralises the basic milieu of the efflux of step (b).

Additionally preferred is a method, whereas the second desalination in step (c) is a reverse osmosis.

Additionally preferred is a method, whereas steps (b) and (c) are executed in one tank, or in two hydraulically not separated tanks.

Additionally preferred is a method, whereas step (b.iii) is a activated carbon adsorption and/or ozonisation and/or UV treatment.

Additionally preferred is a method, whereas the desalination is a complexation of bivalent ions with a complex-forming agent.

Additionally preferred is a method, whereas the complex-forming agent is amino phosphonic acid.

Additionally preferred is a method, whereas the complex-forming agent can be added at ever step before step (b).

Additionally preferred is a method, whereas the method comprises the following steps parallel to one, several or all preceding steps:
(i) separate collection of the partial streams grey water, or one or more of the partial streams thereof and black water or brown water and yellow water, and
(ii) membrane filtration of the separate in (i) collected grey water, or one, or several partial steams thereof.

Additionally preferred is a method, whereas the method comprises the following steps parallel to one, several or all preceding steps:
(iii) removal of carbon of the separate in (i) collected grey water, or one, or several partial steams thereof before or after (ii).

Furthermore, the invention comprises a method, that, if applicable additionally to the above described method steps, comprises the following steps:
(a) drainage of an aqueous liquid fro a storage tank, and
(b) usage of this liquid for toilet flushing, which can comprise the collection of faeces and urine, and
(c) treatment of this liquid, and
(d) feeding this liquid into said storage tank, and
(e) UVC treatment of this liquid in said storage tank, and
(f) repeating steps (a) to (e) one or more times.

Furthermore, the invention comprises a method, that, if applicable additionally to the above described method steps, comprises the following steps:
(a) drainage of an aqueous liquid from a storage tank, and
(b) treatment of this liquid, and
(c) usage of this liquid for toilet flushing, which can comprise the collection of faeces and urine, and
(d) treatment of this liquid, and
(e) feeding this liquid into said storage tank, and
(f) increase of the pH value in said storage tank, or in a tank parallel to the storage tank, and
(g) Repeating steps (a) to (f) one or more times

An alternative embodiment of the invention comprises a device for treatment and loop-processing of waste waters comprising the means as follows:
(a) a means for the separate collection of black water or brown water and yellow water, and
(b) a means for the desalination of a part or total parts of at least one of the separated collected partial streams of (a), and
(c) a means for the reuse of the desalinated liquid phase of (b) to
   (c.i) collection of black water or brown water and/or yellow water in (a), or
   (c.ii) other uses, and
(d) a means for the repetition of the steps (a) to (c) one or more times.

According to the invention a device is preferred, whereas the desalination means (b) comprises an means for ureolysis.

Additionally preferred is a device, whereas the means for desalination in (b) comprises the following means:
(b.a) a means for the ureolysis, and
(b.b) a means for the removal of the nutrient salts.

Furthermore preferred is a device, whereas the means for desalination in (b) as well as the means for removal of nutrient salts in (b.b) is a means for struvite precipitation.

Furthermore preferred is a device, whereas after the means for desalination in (b) comprises the following means:
(c) a means for the second desalination

Moreover preferred is a device, whereas the means for the second desalination comprises a means for the removal of the univalent inorganic salts.

Furthermore preferred is a device, whereas after the means for desalination in (b) comprises the following means:
(a.i) a means for the liquid/solids separation of at least one of the separate collected partial streams obtained in (a)

Furthermore preferred is a device, whereas after the means for desalination in (b) comprises the following means:
(b.i) a means for the oxidation of at least one of in (b) obtained low-salt phases from separate collected black water and/or brown water.

Furthermore preferred is a device, whereas after the means for desalination in (b.i) comprises the following means:
(b.ii) a means for the liquid/solids separation of at least one of the products of (b.i) of separate collected black water and/or brown water

Furthermore preferred is a device, whereas after the means for desalination in (b.ii) comprises the following means:
(b.iii) a means for the UV-Oxidation of the liquid phase of at least one of the products of (b.ii) from separate collected black water and/or brown water

Furthermore preferred is a device, whereas means (b) is a means for ultra or nano filtration.

Furthermore preferred is a device, whereas between means (b.a) and (b.b) a means for metered addition of substances in solid or liquid form.

Furthermore preferred is a device, whereas the means for metered addition comprises the alkali KOH, and/or the substances Mg(CH₃COO)₂ and/or Mg(COO)₂ and/or potassium phosphate compounds with, and/or without hydrogen.

Furthermore preferred is a device, whereas the means for metered addition is proceeded with stoichiometric amounts being adapted to the concentrations of ammonium within the liquid to be treated.

Furthermore preferred is a device, whereas the metered addition of substances is proceeded according to that amount of ammonium, which is necessary, to render the equalisation of the pH decrease, caused by the transformation of ammonium to nitrate, in the oxidation step (b.i) possible, which neutralises the basic milieu of the discharge of step (b).

Furthermore preferred is a device, whereas the means for desalination in step (c) is a means for reverse osmosis.

Furthermore preferred is a device, whereas the means (b) and (c) comprise one holding tank, or in two hydraulically not separated holding tanks.

Furthermore preferred is a device, whereas means (b.iii) is a means for activated carbon adsorption and/or ozonisation and/or UV treatment.

Furthermore preferred is a device, whereas the means for desalination in (b) is a means for complexation of bivalent ions with a complex-forming agent.

Furthermore preferred is a device, whereas the means comprises the complex-forming agent is amino phosphonic acid.

Furthermore preferred is a device, whereas the complex-forming agent can be added at ever step before means (b).

Furthermore preferred is a device, whereas the means comprises the following means parallel to one, several or all preceding means:
(i) a means for the separate collection of the partial streams grey water, or one or more of the partial streams thereof and black water or brown water and yellow water, and
(ii) a means for the membrane filtration of the separate in (i) collected grey water, or one, or several partial steams thereof.

Furthermore preferred is a device, whereas the means comprises the following means parallel to one, several or all preceding means:
(iii) a means for the removal of carbon of the separate in (i) collected grey water, or one, or several partial steams thereof before or after (ii).

Furthermore preferred is a device, comprising the following means:
(a) a means for the drainage of an aqueous liquid fro a storage tank, and
(b) a means for the usage of this liquid for toilet flushing, which can comprise the collection of faeces and urine, and
(c) a means for the treatment of this liquid, and
(d) a means for the feeding this liquid into said storage tank, and
(e) a means for the UVC treatment of this liquid in said storage tank, and
(f) a means for the repeating steps (a) to (e) one or more times

Furthermore preferred is a device, comprising the following means:
(a) a means for the drainage of an aqueous liquid from a storage tank, and
(b) a means for the treatment of this liquid, and
(c) a means for the usage of this liquid for toilet flushing, which can comprise the collection of faeces and urine, and
(d) a means for the treatment of this liquid, and
(e) a means for the feeding this liquid into said storage tank, and
(f) a means for the increase of the pH value in said storage tank, or in a tank parallel to the storage tank, and
(g) a means for the Repeating steps (a) to (f) one or more times

The method according to the invention shall now be explained by means of especially preferred embodiments with exemplary figures.

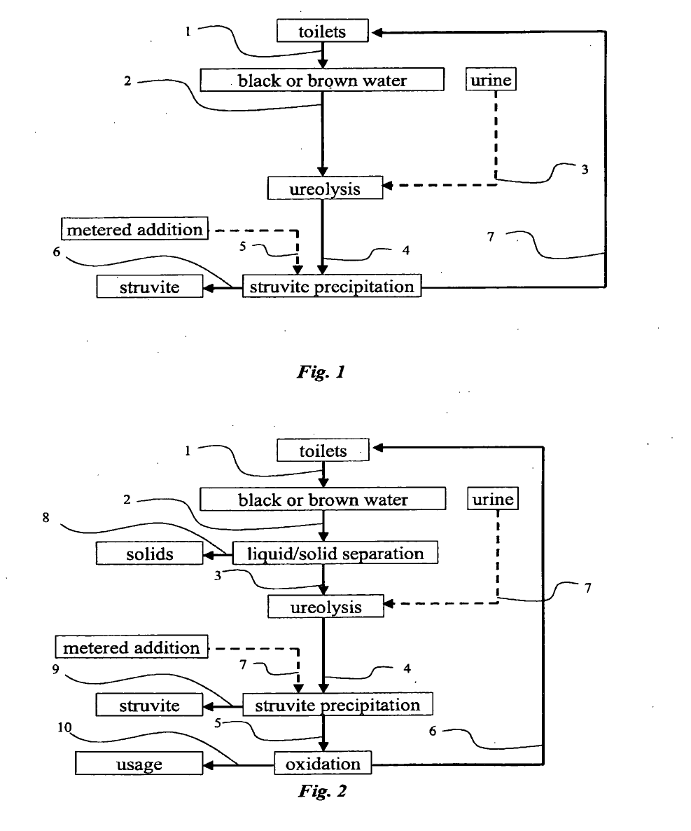

FIG. 1

FIG. 1 shows the method for recovery of nutriets from toilet waste waters.
(1) Shows the drainage of toilet flushing water
(2) Shows the supply to ureolysis. Preferably to ureolysis reactor is a fixed bed reactor, on which the ureolytic bacteria can grow upon. Simultaneously, the ureolysis reactor can have a double function as storage tank for the oxidation step with membrane filtration.
(3) Shows the supply of urine from urinals and/or from the urine drain of urine separation toilets into the ureolysis reactor
(4) Shows the supply into the struvite precipitation. The precipitated struvite is separated preferably through sedimentation, and can then be removed.
(5) Shows the metered addition of substances. These comprise especially preferably KOH to increase the pH value as well as Mg and PO4 salts, to equalised the stoichiometric surplus of NH4 as to increase the struvite yield.
(6) Shows the removal of struvite from the struvite reactor.
(7) Shows the supply of the toilets with nutrient poor black, and/or brown water.

FIG. 2

FIG. 2 shows the method for nutrient recovery as well as the reuse or toilet waste waters for toilet flushing.
(1) Shows the drainage of the toilet flushing water.
(2) Shows the supply into the means of liquid/solids separation.
(3) Shows the supply into the ureolysis. Preferably to ureolysis reactor is an aerated fixed bed reactor, on which the ureolytic bacteria can grow upon. Simultaneously, the ureolysis reactor can have a double function as storage tank for the oxidation step with membrane filtration.
(4) Shows the supply into the struvite precipitation. The precipitated struvite is separated preferably through sedimentation, and can then be removed.
(5) Shows the supply of the oxidation reactor with nutrient poor liquids.
(6) Shows the re-circulating of the treated water for toilet flushing.
(7) Shows the supply of the ureolysis reactor with urine from urinals and/or from the urine drain of urine separation toilets.
(8) Shows the removal of solids from the liquid/solids separation.
(9) Shows the metered addition of substances. These comprise especially preferably KOH to increase the pH value as well as Mg and PO4 salts, to equalised the stoichiometric surplus of NH4 as to increase the struvite yield.
(10) Shows the removal of struvite from the struvite reactor.
(11) Shows the supply of the treated water for other uses.

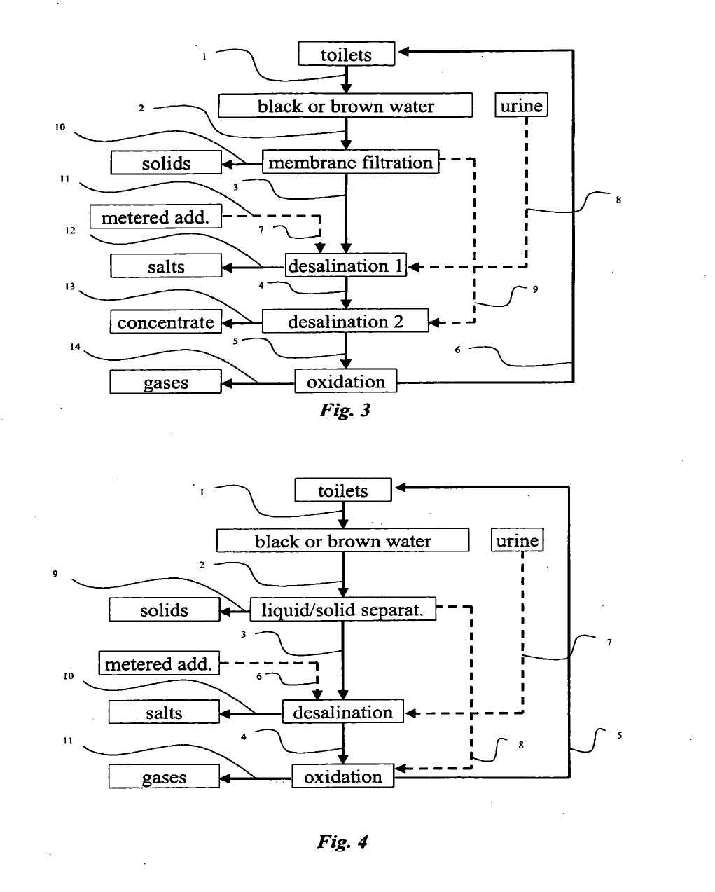

FIG. 3

FIG. 1 shows the black water loop for mobile units in a especially preferred embodiment of the method according to the invention.
(1) shows the drainage of the toilet flushing water.
(2) shows the membrane filtration of the toilet flushing water with removal of the solids (11).
(3) shows the feed-in into the means for desalination 1, in which the bivalent salts and/or nutrients are retained, with removal of the salts (12). In the preferable case of a struvite precipitation shows (7) the metered addition of a base for increasing the pH value. PH increase causes a decrease of the solubility of struvite and struvite precipitates. The metered addition can also be proceeded under stoichiometric addition of magnesium and phosphate, because nitrogen from human excrements is available as surplus. Then, the metered addition comprises preferably MgO and Mg(OH)₂ and/or phosphate.
(4) shows the feed-in into the means for desalination 2, preferably according to the reverse osmosis method, with separation of the salt-containing concentrate (13). Here, the univalent salts are removed as well. The desalination and/or metered addition can take use of the increasing concentration, because the precipitation can be achieved also with increasing concentration. In this case the method steps (3) and (4) can be proceeded in one step, whereas the stoichiometric metered addition con executed here as well, as to increase the yield of struvite.
(5) shows the feed-in of the means for oxidation with discharge of gases or other forms (14). First, the small, low-polar and easily biodegradable molecules are biodegraded in biological reactors. With this method, these substances have the possibility, to pass membrane filtration (ultra filtration), struvite precipitation and desalination 2 (reverse osmosis), because no biological treatment is specifically designed to be. Thus, an oxidation is downstream as to remove these substances from the toilet flushing water. The oxidation is preferably executed with chemical and/or physical methods. However, the removal of these substances can be executed as well with other methods and without oxidation, loki e.g. adsorption (activated carbon).
(6) shows the re-feed of the treated toilet flushing water for reuse as toilet flushing water. One, or more methods for hygienisation can be as intermediary.
(8) shows the alternative method using urine separation toilets. The preferably undiluted urine is collected separately from faeces and toilet flushing water, and feed-in to the means for desalination and treated in the means for desalination 2. according to step (3).
(9) shows the method step for brown water, which can after the membranefiltration directly supplied into the means for oxidation.

FIG. 4

In an especially preferred embodiment of the method according to the invention, FIG. 2 shows the separation of salts for stationary units.
(1) shows the drainage of black, or brown water.
(2) shows the feed-in of the liquid to the means for liquid/solids separation, preferably filtration, with separation of the solids (9).
(3) shows the feed-in of the liquids to the means for desalination. In an especially preferred embodiment, the method according to the invention comprises a method for precipitating the nutrient salts as struvite. The unexpected advantages are here the remarkably decreased aeration, and thus energy demand of the means for oxidation downstream (4), if this is a biological oxidation. Another unexpected advantage compared with PCT/EP98/03316 is here the catch of the nutrients as struvite. Here nitrogen is available in a reduced form as NH₄⁺. NH₄⁺ has much better adsorption properties than NO₃, thus leading to a decreased washing-out of nitrate from fertilised soils into the aquifers.
(6) shows the metered addition of base with the discharge of salts. Also here, the pH increase can be proceeded with MgO and/or Mg(OH₂) and/or under a stoichiometric addition of P and Mg. The decrease of pH is in interaction with preferable biological oxidation downstream.
(4) shows the inflow of the desalinated liquid into the means for oxidation, wich discharge of gases (11). If no stoichiometric precipitation of struvite is executed, dissolved ammonium remains in the inflowing solution. In a biological oxidation, the oxidation causes a transformation of NH₄⁺ to NO₃⁻, and thus a decrease of the pH value. Out of the struvite precipitation flows an aqueous solution with a pH of around 9. In an especially preferred embodiment of the method according to the invention the pH decrease in the means for oxidation equals and neutralises the basic liquids from the struvite precipitation. For the control of the method that means, that only so much nitrogen in the struvite precipitation is precipitated, that sufficient nitrogen remains for neutralisation of the decreased pH value in the liquid.

Is the entire nitrogen removed from blach water, respective urine, by stoichiometric metered addition, then no nitrogen remains for pH decrease in the means for oxidation. Accordingly, the efflux is basic as well. That causes finally a flushing of the toilet with a basic liquid, having an uncontrolled precipitation of struvite in the means comprising the compounds toilet, drainage pipe and liquid/solid separation as consequence. This disadvantages are eliminated with the method according to the invention.

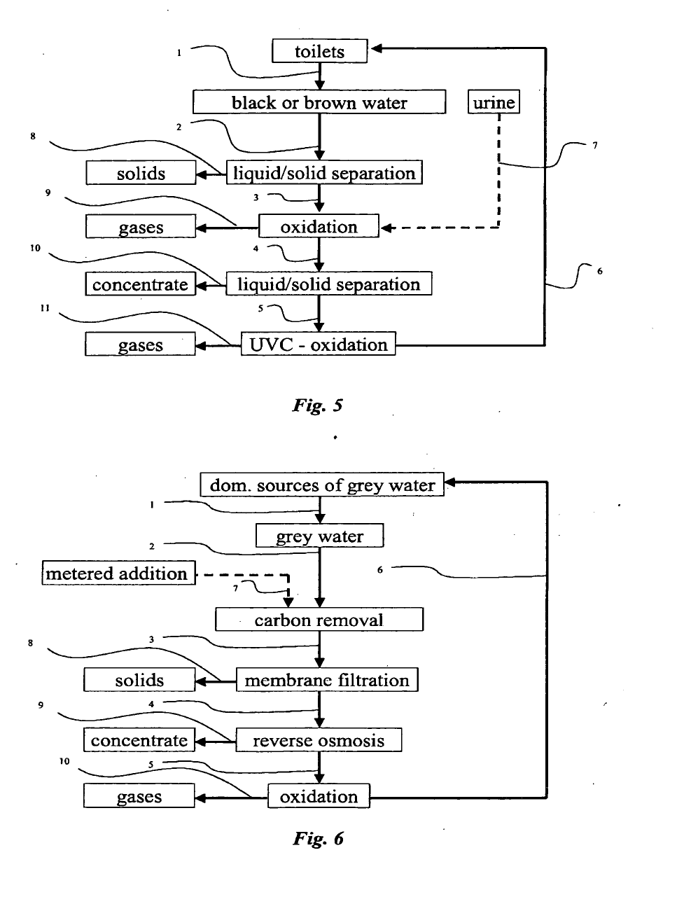

FIG. 5

Another disadvantage of PCT/EP98/03316 is the not further specified chemical and/or physical treatment of the efflux of the means for oxidation. This application teaches the employment of an UVC oxidation (around 185 nm) after the oxidation, as to decolourise the flushing liquid. With UVC the gall bladder substances are endurably destroyed. FIG. 3 shows the embedding of the UVC oxidation in the loop-process in an especially preferred embodiment of the method according to the invention:
(1) shows the drainage of the black, or brown water.
(2) shows the inflow into the liquid/solids separation, preferably a membrane filtration, with extraction of the solids (8).
(3) shows the inflow of the liquids in the means for oxidation with the outflow of gases (9). This can be chemically (ozonisation), or preferably biologically.
(4) shows the influx of the oxidised liquid into the means for liquid/solids separation with disposal of solids (10). In an especially preferred embodiment this is a membrane filtration.
(5) shows the inflowing liquid fraction form (4) into the means for UVC oxidation. Here, the gall bladder substances are broken-up and oxidised due to the hard and short-frequency UV radiation. A re-colouring, as it can be observed with a UV radiation with 260 nm, doesn't happen. Also here gases can evaporate (11).
(6) shows the feedback of the de-coloured liquid for reuse as toilet flushing water.
(7) shows an alteration of the method using urine separation toilets. Urine doesn't need a liquid/solids separation, and can flow directly into the oxidation step.

FIG. 6

Another disadvantage of PCT/EP98/03316 is the biological oxidation of grey water. This method is not suited for mobile units, because the retention time is long and large volumes have to be transported. This application teaches the employment of a chemical treatment of grey water comprising the removal of carbon.
(1) shows the drainage of grey water.
(2) shows the inflow into the means of corbon removal, which is preferably a precipitation.
(3) shows the inflow of the liquid into the membrane filtration with the discharge of solids (8). This is preferably a nano filtration, because with nano filtration the bivalent ions can be retained as well.
(4) shows the inflow of the oxidised liquid into the reverse osmosis with the discharge of salts (10).
(5) shows the outflow of the liquid fraction from (4) into a means for oxidation with the discharge of gases (10). Here the small, un-polar molecules passing the two membranes are oxidised. In an especially preferred embodiment the means for oxidation is an ozonisation.
(6) shows the feedback of the cleaned liquid for reuse for washing water.

1. Method for treatment and loop-processing of waste waters comprising the steps as follows:
(a) separate collection of the partial streams grey water, or one or more of the partial streams thereof and black water or brown water and yellow water, and
(b) desalination of a part or total parts of at least one of the separated collected partial streams of (a), and
(c) reuse of the desalinated liquid phase of (b) to
(c.i) collection of black water or brown water and/or yellow water in (a), or
(c.ii) other uses, and
(d) repetition of the steps (a) to (c) one or more times.

2. Method according to claim 1, whereas the desalination in step (b) comprises an ureolysis.

3. Method according to claim 1, whereas the desalination in step (b) comprises the following steps:
(b.a) ureolysis, and
(b.b) removal of the nutrient salts.

4. Method according to claim 1, whereas the desalination according to claim 1), step (b), as well as the removal of nutrient salts of claim 3), step (b) is a struvite precipitation.

5. Method according to claim 1, whereas after the desalination in step (b) the following step is proceeded:
(c) second desalination.

6. Method according to claim 5, whereas the second desalination comprises the univalent inorganic salts.

7. Method according to claim 1, whereas before step (b) the following step is proceeded:
(a.i) Liquid/solids separation of at least one of the separate collected partial streams obtained in (a).

8. Method according to claim 1, whereas after step (b) the following step is proceeded:
(b.i) oxidation of at least one of in (b) obtained low-salt phases from separate collected black water and/or brown water.

9. Method according to claim 8, whereas after step (b.i) the following step is proceeded:
(b.ii) liquid/solids separation of at least one of the products of (b.i) of separate collected black water and/or brown water.

10. Method according to claim 9, whereas after step (b.ii) the following step is proceeded:
(b.iii) UV-Oxidation of the liquid phase of at least one of the products of (b.ii) from separate collected black water and/or brown water.

11. Method according to claim 1, whereas step (b) is a ultra or nano filtration.

12. Method according to claim 3 whereas between step (b.a) and (b.b) a metered addition of substances in solid or liquid form.

13. Method according to claim 12, whereas the metered addition comprises the alkali KOH, and/or the substances Mg(CH₃COO)₂ and/or Mg(COO)₂ and/or potassium phosphate compounds with, and/or without hydrogen.

14. Method according to claim 13, whereas the metered addition is proceeded with stoichiometric amounts being adapted to the concentrations of ammonium within the liquid to be treated.

15. Method and device according to claim 12, whereas the metered addition of substances is proceeded according to that amount of ammonium, which is necessary, to render the equalisation of the pH decrease, caused by the transformation of ammonium to nitrate, in the oxidation of step (b.i) possible, which neutralises the basic milieu of the discharge of step (b).

16. Method according to claim 5, whereas the desalination in step (c) is a reverse osmosis.

17. Method according to claim 1, whereas steps (b) and (c) are executed in one holding tank, or in two hydraulically not separated holding tanks.

18. Method according to claim 10, whereas step (b.iii) is a activated carbon adsorption and/or ozonisation and/or UV treatment.

19. Method according to claim 1, whereas the desalination is a complexation of bivalent ions with a complex-forming agent.

20. Method according to claim 19, whereas the complex-forming agent is amino phosphonic acid.

21. Method according to claim 19, whereas the complex-forming agent can be added at ever step before step (b).

22. Method according to claim 1, whereas the method comprises the following steps parallel to one, several or all preceding steps:
(i) separate collection of the partial streams grey water, or one or more of the partial streams thereof and black water or brown water and yellow water, and
(ii) membrane filtration of the separate in (i) collected grey water, or one, or several partial steams thereof.

23. Method according to claim 1, whereas the method comprises the following steps parallel to one, several or all preceding steps:
(iii) removal of carbon of the separate in (i) collected grey water, or one, or several partial steams thereof before or after (ii).

24. Method according to claim 10, comprising the following steps:
(a) drainage of an aqueous liquid fro a storage tank, and
(b) usage of this liquid for toilet flushing, which can comprise the collection of faeces and urine, and
(c) treatment of this liquid, and
(d) feeding this liquid into said storage tank, and
(e) UVC treatment of this liquid in said storage tank, and
(f) repeating steps (a) to (e) one or more times.

25. Method according to claim 4, comprising the following steps:
(a) drainage of an aqueous liquid from a storage tank, and
(b) treatment of this liquid, and
(c) usage of this liquid for toilet flushing, which can comprise the collection of faeces and urine, and
(d) treatment of this liquid, and
(e) feeding this liquid into said storage tank, and
(f) increase of the pH value in said storage tank, or in a tank parallel to the storage tank, and
(g) Repeating steps (a) to (f) one or more times.

26. Device for treatment and loop-processing of waste waters comprising the means as follows:
(a) a means for the separate collection of the partial streams black water or brown water and yellow water, and
(b) a means for the desalination of a part or total parts of at least one of the separated collected partial streams of (a), and
(c) a means for the use of the desalinated liquid phase of (b) to
(c.i) collection of black water or brown water and/or yellow water in (a), or
(c.ii) other uses, and
(d) a means for the repetition of the steps (a) to (c) one or more times.

27. Device according to claim 26, whereas the desalination means (b) comprises an means for ureolysis.

28. Device according to claim 26, whereas the means for desalination in (b) comprises the following means:
(b.a) a means for the ureolysis, and
(b.b) a means for the removal of the nutrient salts.

29. Device according to claim 26, whereas the means for desalination, (b), is a means for struvite precipitation.

30. Device according to claim 26, whereas after the means for desalination in (b) comprises the following means:
(c) a means for the second desalination.

31. Device according to claim 30, whereas the means for the second desalination comprises a means for the removal of the univalent inorganic salts.

32. Device according to claim 26, which before means (b) comprises the following means:
(a.i) a means for the liquid/solids separation of at least one of the separate collected partial streams obtained in (a).

33. Device according to claim 26, which comprises after means (b) the following means:
(b.i) a means for the oxidation of at least one of in (b) obtained low-salt phases from separate collected black water and/or brown water.

34. Device according to claim 33, which comprises after means (b.i) the following means:
(b.ii) a means for the liquid/solids separation of at least one of the products of (b.i) of separate collected black water and/or brown water.

35. Device according to claim 34, which comprises after means (b.ii) the following means:
(b.iii) a means for the UV-Oxidation of the liquid phase of at least one of the products of (b.ii) from separate collected black water and/or brown water.

36. Device according to claim 26, whereas means (b) is a means for ultra or nano filtration.

37. Device according to claim 26, whereas between means (b.a) and (b.b) a means for metered addition of substances in solid or liquid form.

38. Device according to claim 37, whereas the means for metered addition comprises the alkali KOH, and/or the substances Mg(CH₃COO)₂ and/or Mg(COO)₂ and/or potassium phosphate compounds with, and/or without hydrogen.

39. Device according to claim 38, whereas the means for metered addition is proceeded with stoichiometric amounts being adapted to the concentrations of ammonium within the liquid to be treated.

40. Device according to claim 38, whereas the metered addition of substances is proceeded according to that amount of ammonium, which is necessary, to render the equalisation of the pH decrease, caused by the transformation of ammonium to nitrate, in the oxidation of step (b.i) possible, which neutralises the basic milieu of the discharge of step (b).

41. Device according to claim 30, whereas the means for desalination in step (c) is a means for reverse osmosis.

42. Device according to claim 26, whereas the means (b) and (c) comprise one holding tank, or in two hydraulically not separated holding tanks.

43. Device according to claim 35, whereas means (b.iii) is a means for activated carbon adsorption and/or ozonisation and/or UV treatment.

44. Device according to claim 26, whereas the means for desalination in (b) is a means for complexation of bivalent ions with a complex-forming agent.

45. Device according to claim 44, whereas the means comprises the complex-forming agent is amino phosphonic acid.

46. Device according to claim 44, whereas the complex-forming agent can be added with a means for metered addition at ever step before means (b).

47. Device according to claim 26, whereas the means comprises the following means parallel to one, several or all preceding means:
(i) a means for the separate collection of the partial streams grey water, or one or more of the partial streams thereof and black water or brown water and yellow water, and
(ii) a means for the membrane filtration of the separate in (i) collected grey water, or one, or several partial steams thereof.

48. Device according to claim 26, whereas the means comprises the following means parallel to one, several or all preceding means:
(iii) a means for the removal of carbon of the separate in (i) collected grey water, or one, or several partial steams thereof before or after (ii).

49. Device according to claim 35, comprising the following means:
(a) a means for the drainage of an aqueous liquid from a storage tank, and
(b) a means for the usage of this liquid for toilet flushing, which can comprise the collection of faeces and urine, and
(c) a means for the treatment of this liquid, and
(d) a means for the feeding this liquid into the storage tank, and
(e) a means for the UVC treatment of this liquid in the storage tank, and
(f) a means for the repeating steps (a) to (e) one or more times.

50. Device according to claim 28, comprising the following means:
(a) a means for the drainage of an aqueous liquid from a storage tank, and
(b) a means for the treatment of this liquid, and
(c) a means for the usage of this liquid for toilet flushing, which can comprise the collection of faeces and urine, and
(d) a means for the treatment of this liquid, and
(e) a means for the feeding this liquid into the storage tank, and
(f) a means for the increase of the pH value in the storage tank, or in a tank parallel to the storage tank, and
(g) a means for the Repeating steps (a) to (f) one or more times.

51. Device according to claims 28, whereas the means for removal of nutrient salts, (b), is a means for struvite precipitation.
